(19) United States
(12) Patent Application Publication
(10) Pub. No.: US 2026/0135441 A1
(43) Pub. Date: May 14, 2026

(54) DRIVING DEVICE FOR VEHICLE

(71) Applicant: TOYOTA JIDOSHA KABUSHIKI KAISHA, Toyota-shi (JP)

(72) Inventor: Takayuki NISHIDA, Nagoya-shi (JP)

(73) Assignee: TOYOTA JIDOSHA KABUSHIKI KAISHA, Toyota-shi (JP)

(21) Appl. No.: 19/375,677

(22) Filed: Oct. 31, 2025

(30) Foreign Application Priority Data
Nov. 14, 2024 (KR) 2024-199283

(51) Int. Cl. H02K 9/19; B60K 1/00; H02K 5/20; H02K 7/00

(52) U.S. Cl. CPC H02K 9/19; B60K 1/00; H02K 5/203; H02K 7/006; B60K 2001/006

(57) ABSTRACT

A driving device for a vehicle may include: a rotary electrical machine having a hollow output shaft extending along an axial direction; a case housing the rotary electrical machine; an intermediate shaft extending in a through hole of the output shaft along the axial direction and configured to transmit torque of the rotary electrical machine to wheels of a vehicle; and a bearing having an outer ring fixed to the case and an inner ring fixed to the output shaft, in which the intermediate shaft has a first channel configured to supply coolant to the rotary electrical machine, the case has a second channel configured to supply the coolant to the first channel, and a part of the second channel extends in proximity to the outer ring fixed to the case along a circumferential direction of the outer ring.

### CROSS REFERENCE TO RELATED APPLICATIONS

This application claims priority from Japanese Patent Application No. 2024-199283 filed on November 14, 2024. The entire content of the priority application is incorporated herein by reference.

### TECHNICAL FIELD

The art disclosed herein relates to a driving device for a vehicle.

### BACKGROUND ART

A hollow output shaft having a rotary electrical machine and an intermediate shaft extending along an axis of the rotary electrical machine within a through hole of the output shaft are known. The intermediate shaft transmits the torque of the rotary electrical machine to wheels of a vehicle. In addition, the output shaft is rotatably supported by a bearing relative to a case that houses the rotary electrical machine.

The intermediate shaft is provided with a channel for supplying coolant to the rotary electrical machine. The coolant is supplied to the channel provided in the intermediate shaft from a channel provided in the case that houses the rotary electrical machine.

### SUMMARY

As a temperature inside the case rises, a gap may be formed between the bearing and the case. This is because the linear expansion coefficients of the bearing and the case are different. This gap can cause deterioration in a noise which is transmitted from the rotary electrical machine to the case. This specification provides a technique for suppressing deterioration in noise transmitted from a rotary electrical machine to a case.

A driving device for a vehicle disclosed herein may comprise: a rotary electrical machine having a hollow output shaft extending along an axial direction; a case housing the rotary electrical machine; an intermediate shaft extending in a through hole of the output shaft along the axial direction and configured to transmit torque of the rotary electrical machine to wheels of a vehicle; and a bearing having an outer ring fixed to the case and an inner ring fixed to the output shaft, and supporting the output shaft rotatably relative to the case, wherein the intermediate shaft has a first channel configured to supply coolant to the rotary electrical machine, the case has a second channel configured to supply the coolant to the first channel, and a part of the second channel extends in proximity to the outer ring fixed to the case along a circumferential direction of the outer ring.

### BRIEF DESCRIPTION OF DRAWINGS

FIG. 1 is a schematic diagram showing a configuration of a vehicle.

FIG. 2 is a skeleton diagram showing a driving device mounted on the vehicle.

FIG. 3 is a sectional view of main parts around an output shaft and a bearing.

FIG. 4 is a sectional view along a line IV-IV in FIG. 3.

### DETAILED DESCRIPTION

In one aspect of the present teachings, a driving device for a vehicle may comprise: a rotary electrical machine having a hollow output shaft; a housing for the rotary electrical machine; an intermediate shaft extending through a through hole of the output shaft along an axial direction of the rotary electrical machine and configured to transmit torque from the rotary electrical machine to wheels of a vehicle; and a bearing having an outer ring fixed to the housing and an inner ring fixed to the output shaft, and supporting the output shaft rotatably relative to the housing, wherein the intermediate shaft has a first channel configured to supply coolant to the rotary electrical machine, the case has a second channel configured to supply the coolant to the first channel, and a part of the second channel extends in proximity to the outer ring fixed to the case along a circumferential direction of the outer ring.

In the above-mentioned driving device for a vehicle, a part of the second channel provided in the case extends in the circumferential direction of the outer ring of the bearing. As a result, both the bearing and the case are cooled by the second channel. By cooling both the bearing and the case, thermal expansion of the bearing and the case is suppressed, thereby suppressing the occurrence of a gap between the bearing and the case. As a result, deterioration of noise transmitted from the rotary electrical machine to the case can be suppressed.

Representative, non-limiting examples of the present disclosure will now be described in further detail with reference to the attached drawings. This detailed description is merely intended to teach a person skilled in the art further details for practicing preferred aspects of the present teachings and is not intended to limit the scope of the disclosure. Furthermore, each of the additional features and teachings disclosed below may be utilized separately or in conjunction with other features and teachings to provide improved driving devices for a vehicle, as well as methods for using and manufacturing the same.

Moreover, combinations of features and steps disclosed in the following detailed description may not be necessary to practice the disclosure in the broadest sense, and are instead taught merely to particularly describe representative examples of the disclosure. Furthermore, various features of the above-described and below-described representative examples, as well as the various independent and dependent claims, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter.

With reference to the accompanying drawings, the driving device mounted on a vehicle will be described below. Here, the directions in the drawings correspond to the directions of the vehicle. The direction FR indicates the front of the vehicle in the front-rear direction, and the direction RR indicates the rear of the vehicle in the front-rear direction. Furthermore, the direction LH indicates the left side of the vehicle in the left-right direction, and the direction RH indicates the right side of the vehicle in the left-right direction. The direction UP indicates the upper side of the vehicle in the up-down direction, and the direction DW indicates the lower side of the vehicle in the up-down direction.

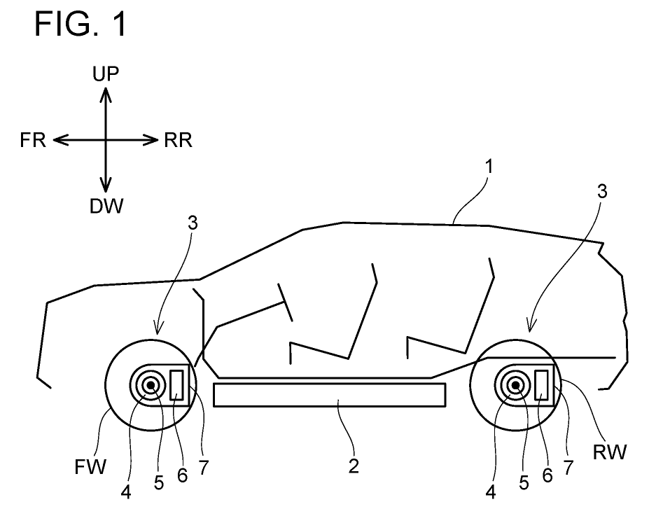

FIG. 1 illustrates a configuration of a vehicle 1. Note that the vehicle 1 is a vehicle having at least a rotary electrical machine as one of driving sources, and may be, for example, a battery electric vehicle, a hybrid electric vehicle, or a fuel cell electric vehicle.

The vehicle 1 is equipped with a battery pack 2 mounted below a floor and a pair of driving devices 3. The battery pack 2 supplies power to each of the pair of driving devices 3. One of the pair of driving devices 3 uses the supplied power to drive front wheels FW, and the other of the pair of driving devices 3 uses the supplied power to drive rear wheels RW. Note that the vehicle 1 is illustrated as a four-wheel drive vehicle, but it may also be a two-wheel drive vehicle equipped with only one of the pair of driving devices 3. The pair of driving devices 3 have the same structure as each other. Hereinafter, the pair of driving devices 3 will be described without distinction from each other.

The driving device 3 includes a rotary electrical machine 4, a transmission device 5, a power control unit 6, and a case 7. The rotary electrical machine 4, the transmission device 5, and the power control unit 6 are housed within the case 7. The power control unit 6 is positioned adjacent to the rotary electrical machine 4 and the transmission device 5 in the front-rear direction of the vehicle (in this example, toward the rear of the vehicle). The power control unit 6 converts electrical power supplied from the battery pack 2 from direct current to alternating current and supplies the same to the rotary electrical machine 4. The rotary electrical machine 4 generates driving force based on the alternating current supplied from the power control unit 6. The transmission device 5 distributes the driving force generated by the rotary electrical machine 4 to the left and right wheels after amplifying the torque.

The rotary electrical machine 4 and the transmission device 5 are arranged coaxially. As a result, a dimension in the vehicle up-down direction of the case 7 housing the rotary electrical machine 4 and the transmission device 5 is reduced. Thus, the case 7 is arranged so that the case 7 fits within a range of the corresponding wheels FW or RW when viewed along the vehicle left-right direction. As a result, for example, on the front side of the vehicle 1, freedom of arrangement of various mechanical components, such as a radiator and an air conditioning control system, is improved, enabling a larger user space to be secured. Additionally, on the rear side of the vehicle 1, for example, a larger trunk space can be secured, or the range of reclining angle of the rear seat(s) can be largely secured.

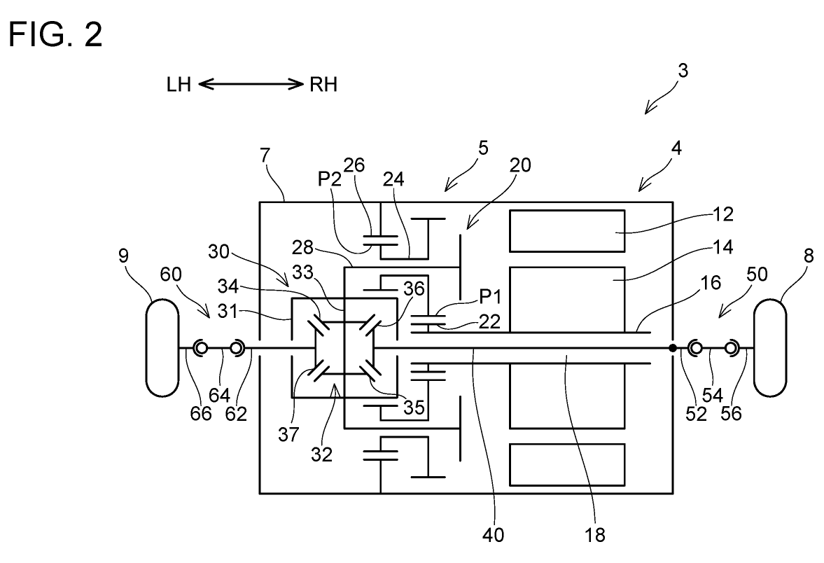

FIG. 2 shows a skeleton diagram of the driving device 3, including the rotary electrical machine 4 and the transmission device 5, housed within the case 7. In this example, the rotary electrical machine 4 is disposed on the right side of the case 7, and the transmission device 5 is disposed on the left side of the case 7. Alternatively, the transmission device 5 may be disposed on the right side of the case 7, and the rotary electrical machine 4 may be disposed on the left side of the case 7. For sake of convenience in the following description, the names of components may include left and right directions, but such designations do not limit the positions of the components.

The rotary electrical machine 4 comprises a stator core 12, a rotor 14, an output shaft 16, and a rotor 14. The stator core 12 is fixed to the case 7. The rotor 14 is supported by the case 7 such that the rotor 14 can rotate around the rotational axis of the rotary electrical machine 4. The output shaft 16 is connected to the rotor 14 and rotates integrally with the rotor 14. The output shaft 16 is hollow and has a through hole 18 extending along the rotational axis direction of the rotary electrical machine 4.

The transmission device 5 includes a planetary gear part 20 and a differential gear 30. The planetary gear part 20 reduces the rotation of the output shaft 16 of the rotary electrical machine 4. The differential gear 30 distributes the driving force of the rotary electrical machine 4 transmitted through the planetary gear part 20 to a right wheel 8 and a left wheel 9. The rotary electrical machine 4, the planetary gear part 20, and the differential gear 30 are coaxially arranged. Note that the configuration of the transmission device 5 described below is an example, and other types of configurations may be adopted as appropriate.

The planetary gear part 20 comprises a sun gear 22, a plurality of stepped pinion gears 24, a ring gear 26, and a carrier 28. The sun gear 22 is connected to the output shaft 16 of the rotary electrical machine 4 and rotates integrally with the output shaft 16. Each of the plurality of stepped pinion gears 24 has a large-diameter pinion gear P1 and a small-diameter pinion gear P2, which is smaller in diameter than the large-diameter pinion gear P1. The large-diameter pinion gear P1 meshes with the sun gear 22. The small-diameter pinion gears P2 mesh with the ring gear 26. The ring gear 26 is fixed to the case 7. The carrier 28 rotatably supports each of the plurality of stepped pinion gears 24. Thus, the planetary gear part 20 has the sun gear 22 as its input element, the ring gear 26 as its reaction element, and the carrier 28 as its output element.

The differential gear 30 comprises a differential case 31 and a differential gear mechanism 32. The differential case 31 is supported by the case 7 so as to be rotatable around the rotational axis of the rotary electrical machine 4. The differential case 31 is connected to the carrier 28 of the planetary gear part 20 and rotates integrally with the carrier 28. The differential gear mechanism 32 is housed within the differential case 31.

The differential gear mechanism 32 includes a pinion shaft 33, a pair of differential pinion gears 34 and 35, a right side gear 36, and a left side gear 37.

The pinion shaft 33 is connected to the differential case 31 and rotates integrally with the differential case 31. The pinion shaft 33 extends within the differential case 31 in a direction perpendicular to the rotational axis of the rotary electrical machine 4. Each of the pair of differential pinion gears 34 and 35 is supported on the pinion shaft 33 such that it can rotate around the axis of the pinion shaft 33. The right side gear 36 is a component that outputs driving force to the right wheel 8 and meshes with each of the pair of differential pinion gears 34 and 35. The left side gear 37 is a component that outputs driving force to the left wheel 9 and meshes with each of the pair of differential pinion gears 34 and 35.

The driving device 3 further includes an intermediate shaft 40, a right drive shaft 50 connected to the right wheel 8, and a left drive shaft 60 connected to the left wheel 9.

The intermediate shaft 40 extends along the rotational axis direction of the rotary electrical machine 4 through the through hole 18 of the output shaft 16. The left end of the intermediate shaft 40 is connected to the right side gear 36 of the differential gear 30, and the right end of the intermediate shaft 40 is connected to the right drive shaft 50. That is, the intermediate shaft 40 transmits the torque of the rotary electrical machine 4, which is transmitted through the output shaft 16, the planetary gear part 20, and the differential gear mechanism 32, to the right wheel 8.

The right drive shaft 50 includes a drive shaft inboard 52, an intermediate drive shaft 54, and a drive shaft outboard 56. The drive shaft inboard 52 is a left end portion of the right drive shaft 50 in the axial direction, which is inserted into the case 7, and refers to a portion from its constant velocity joint to its left end face. The drive shaft outboard 56 is a right end portion of the

right drive shaft 50 in the axial direction, which is connected to the right wheel 8, and refers to a portion from the constant velocity joint to its right end face. The drive shaft inboard 52 of the right drive shaft 50 is connected to the right side gear 36 of the differential gear 30 via the intermediate shaft 40. The driving force output by the right side gear 36 is transmitted to the right drive shaft 50 via the intermediate shaft 40.

The left drive shaft 60 includes a drive shaft inboard 62, an intermediate drive shaft 64, and a drive shaft outboard 66. The drive shaft inboard 62 is a right end portion of the left drive shaft 60 in the axial direction, which is inserted into the case 7, and refers to a portion from its constant velocity joint to its right end face. The drive shaft outboard 66 is a left end portion of the left drive shaft 60 in the axial direction, which is connected to the left wheel 9, and refers to a portion from the constant velocity joint to its left end face. The drive shaft inboard 62 of the left drive shaft 60 is connected to the left side gear 37 of the differential gear 30. The driving force output by the left side gear 37 is directly transmitted to the left drive shaft 60.

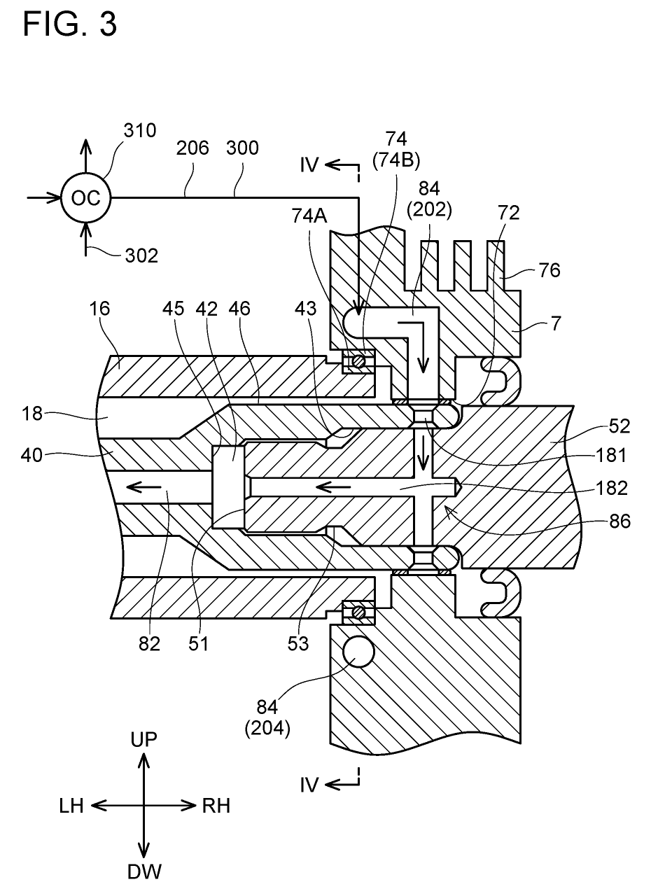

FIG. 3 shows a cross-sectional view of vicinity of the intermediate shaft 40 and the drive shaft inboard 52 of the right drive shaft 50. A mating hole 42 is defined at the right end of the intermediate shaft 40, into which the left end of the drive shaft inboard 52 is fitted. An opening72 is provided in the case 7, through which both the right end of the intermediate shaft 40 and the left end of the drive shaft inboard 52 pass.

A bearing 74 is fixed to the case 7 in coaxial alignment with the opening 72. An outer ring 74B of the bearing 74 is fixed to the inner surface of the case 7. An inner ring 74A of the bearing 74 is fixed to the outer peripheral surface of the right end of the output shaft 16. The bearing 74 rotatably supports the output shaft 16 relative to the case 7.

The driving device 3 has a channel through which a lubricant 300 flows to lubricate and cool lubrication target part(s) within the rotary electrical machine 4 and the transmission device 5. This channel is provided in the intermediate shaft 40 and the case 7.

The intermediate shaft 40 is provided with a first channel 82 extending in the axial direction of the intermediate shaft 40. One end of the first channel 82 opens at a bottom surface 45 of the mating hole 42. The intermediate shaft 40 is provided with one or more supply holes extending from the first channel 82 to the outer peripheral surface in a direction perpendicular to the axial direction of the intermediate shaft 40 at position(s) where a lubrication target part is located. The lubricant 300 supplied to the first channel 82 is supplied to the lubrication target part through the one or more supply holes.

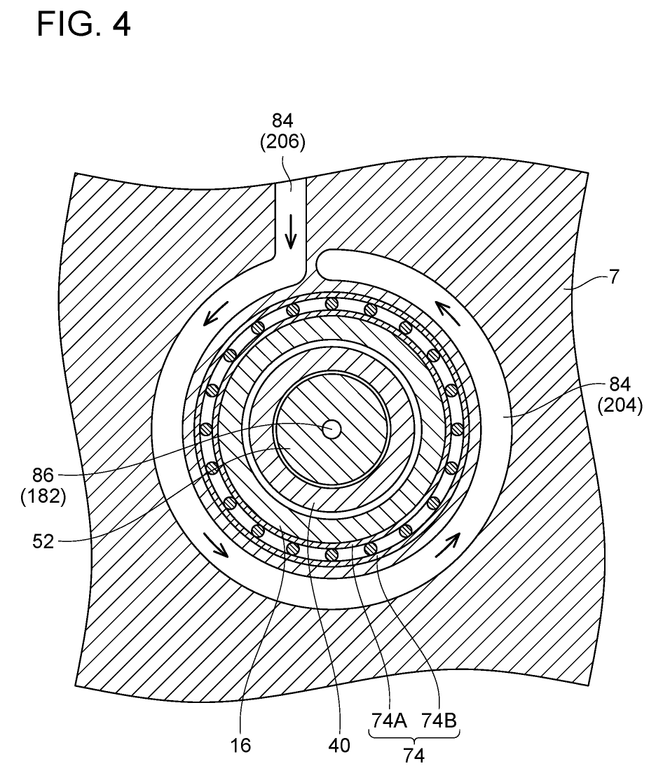

The case 7 is provided with a second channel 84 configured to supply the lubricant 300 to the first channel 82. As shown in FIGS. 3 and 4, the second channel 84 includes a first partial channel 202, a second partial channel 204, and a third partial channel 206. One end of the first

partial channel 202 opens onto a surface defining the opening 72. The other end of the first partial channel 202 is connected to one end of the second partial channel 204. As shown in FIG. 4, the second partial channel 204 extends along the circumferential direction of the outer ring 74B of the bearing 74 in proximity to the outer ring 74B. The second partial channel 204 extends over an angular range of 180 degrees or more in the circumferential direction of the outer ring 74B. In this embodiment, the angular range is approximately 360 degrees. Approximately 360 degrees refers to a value within a range of 330 degrees to 360 degrees.

The other end of the second partial channel 204 is connected to one end of the third partial channel 206. The other end of the third partial channel 206 is connected to an oil cooler 310. The oil cooler 310 performs heat exchange between another coolant 302 and the lubricant 300. The other coolant 302 flows through another channel isolated from the channel through which the lubricant 300 flows. The oil cooler 310 is configured to cool the lubricant 300 supplied to the third partial channel 206. In a modification, the driving device 3 may not comprise the oil cooler 310.

A third channel 86 is provided in a portion formed by both the right end of the intermediate shaft 40 and the left end of the drive shaft inboard 52. The third channel 86 includes a first communication channel 181 provided in the intermediate shaft 40 and a second communication channel 182 provided in the drive shaft inboard 52.

The first communication channel 181 is a through hole that extends in the radial direction of the intermediate shaft 40 through a portion of the intermediate shaft 40 surrounding the mating hole 42. One end of the first communication channel 181 opens to an outer peripheral surface 46 of the intermediate shaft 40, and the other end of the first communication channel 181 opens to an inner peripheral surface 43 of the intermediate shaft 40. When viewed along the radial direction of the intermediate shaft 40, a section where the second channel 84 exists at the opening 72 of the case 7 overlaps with a section where the first communication channel 181 exists on the outer peripheral surface 46 of the intermediate shaft 40.

The second communication channel 182 is a through hole extending within the drive shaft inboard 52. One end of the second communication channel 182 opens to an outer peripheral surface 53 of the drive shaft inboard 52, and the other end of the second communication channel 182 opens to a left end face 51 of the drive shaft inboard 52. The first communication channel 181 and the second communication channel 182 are opposed to each other between the inner peripheral surface 43 of the intermediate shaft 40 and the outer peripheral surface 53 of the drive shaft inboard 52.

The arrow extending from the oil cooler 310 and the arrows shown within each channel 82, 84, and 86 indicate the direction of the lubricant 300 flowing from the oil cooler 310 into each channel 82, 84, and 86. The lubricant 300 supplied from the oil cooler 310 to the third partial channel 206 passes through the second partial channel 204 and is supplied to the first partial

channel 202. The lubricant 300 supplied to the first partial channel 202 is supplied to the first communication channel 181 of the third channel 86. The lubricant 300 supplied to the first communication channel 181 passes through the second communication channel 182 and is supplied to the first channel 82. The lubricant 300 supplied to the first channel 82 is supplied to the lubrication target part(s) and returns to the oil cooler 310.

### Effects by Present Embodiment

As the temperature inside case 7 rises, a gap may be formed between the bearing 74 and the case 7. This is due to the difference in the linear expansion coefficients of materials of the bearing 74 and the case 7, because the bearing 74 and the case 7 are constituted of different materials. The material of the bearing 74 is, for example, iron, and the material of the case 7 is, for example, aluminum. The above gap may cause deterioration of noise transmitted from the rotary electrical machine 4 to the case 7.

According to the configuration of the present embodiment, the second partial channel 204 extends along the circumferential direction near the outer ring 74B of the bearing 74. As a result, both the bearing 74 and the case 7 are cooled by the second partial channel 204. By cooling both the bearing 74 and the case 7, thermal expansion of the bearing 74 and the case 7 is suppressed, thereby suppressing the occurrence of a gap between the bearing 74 and the case 7. As a result, deterioration of noise transmitted from the rotary electrical machine 4 to the case 7 can be suppressed.

In the present embodiment, the second partial channel 204 extends over an angle range of 180 degrees or more in the circumferential direction of the outer ring 74B. This allows more than a half of the entire circumference of the outer ring 74B of the bearing 74 to be cooled. In a modification, the second partial channel 204 may extend over an angular range of less than 180 degrees in the circumferential direction of the outer ring 74B.

Furthermore, as shown in FIG. 3, a plurality of heat dissipation fins 76 is provided on the outer surface of the case 7. The direction in which the heat dissipation fins 76 extend may be the up-down direction or the left-right direction. The second channel 84, particularly the first partial channel 202, passes through a section of the case 7 on which the plurality heat dissipation fins 76 is provided. The heat dissipation fins 76 can promote heat dissipation of the lubricant 300 within the second channel 84. In a modification, the driving device 3 may not comprise the heat dissipation fins 76.

### Correspondence Relations

The driving device 3 is an example of “driving device for a vehicle”. The rotary electrical machine 4 and the case 7 are examples of “rotary electrical machine” and “case,” respectively. The lubricant 300 is an example of “coolant.” The right wheel 8 is an example of “wheels”. The output

shaft 16 and the through hole 18 are examples of “output shaft” and “through hole,” respectively. The intermediate shaft 40 is an example of “intermediate shaft”. The bearing 74, the inner ring 74A, and the outer ring 74B are examples of “bearing”, “outer ring”, and “inner ring”, respectively. The first channel 82 and the second channel 84 are examples of “first channel” and “second channel”, respectively. The oil cooler 310 is an example of “cooler”. The heat dissipation fins 76 are an example of “heat dissipation fins”.

Some of the points to be noted regarding the technology shown in the embodiment will be described. The driving device 3 may not necessarily include the third channel 86. In this modification, the drive shaft inboard 52 may not necessarily include the additional opening 72. Furthermore, the second channel 84 may directly communicate with the first channel 82.

While specific examples of the present disclosure have been described above in detail, these examples are merely illustrative and place no limitation on the scope of the patent claims. The technology described in the patent claims also encompasses various changes and modifications to the specific examples described above. The technical elements explained in the present description or drawings provide technical utility either independently or through various combinations. The present disclosure is not limited to the combinations described at the time the claims are filed. Further, the purpose of the examples illustrated by the present description or drawings is to satisfy multiple objectives simultaneously, and satisfying any one of those objectives gives technical utility to the present disclosure.

What is claimed is:

1. A driving device for a vehicle, the driving device comprising:
a rotary electrical machine having a hollow output shaft extending along an axial direction;
a case housing the rotary electrical machine;
an intermediate shaft extending in a through hole of the output shaft along the axial direction and configured to transmit torque of the rotary electrical machine to wheels of a vehicle; and
a bearing having an outer ring fixed to the case and an inner ring fixed to the output shaft, and supporting the output shaft rotatably relative to the case,
wherein the intermediate shaft has a first channel configured to supply coolant to the rotary electrical machine,
the case has a second channel configured to supply the coolant to the first channel, and
a part of the second channel extends in proximity to the outer ring fixed to the case along a circumferential direction of the outer ring.

2. The driving device according to claim 1, wherein the second channel extends over an angular range of 180 degrees or more in the circumferential direction.

3. The driving device according to claim 1, further comprising a cooler configured to cool the coolant, wherein the cooler is configured to cool the coolant supplied to the second channel.

4. The driving device according to claim 1, further comprising a plurality of heat dissipation fins provided on an outer surface of the case, wherein the second channel passes through a section of the case on which the plurality of heat dissipation fins is provided.
